(19) United States
(12) Patent Application Publication
(10) Pub. No.: US 2010/0292986 A1
(43) Pub. Date: Nov. 18, 2010

(54) ENCODER

(75) Inventors: Adriana Vasilache, Tampere (FI); Anssi Ramo, Tampere (FI); Lasse Laaksonen, Nokia (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/531,667

(22) PCT Filed: Mar. 16, 2007
(86) PCT No.: PCT/IB07/00866

§ 371 Date: May 25, 2010

(51) Int. Cl. G10L 19/14

(52) U.S. Cl. 704/219; 704/E19.039

(57) ABSTRACT

An encoder is configured to receive an audio signal and output a scaled encoded signal. The encoder is further configured to generate a synthesized audio signal and an encoded signal. The encoder is further configured to scale the encoded signal dependent on the synthesized audio signal.

### FIELD OF THE INVENTION

The present invention relates to coding, and in particular, but not exclusively to speech or audio coding.

### BACKGROUND OF THE INVENTION

Audio signals, like speech or music, are encoded for example for enabling an efficient transmission or storage of the audio signals.

Audio encoders and decoders are used to represent audio based signals, such as music and background noise. These types of coders typically do not utilise a speech model for the coding process, rather they use processes for representing all types of audio signals, including speech.

Speech encoders and decoders (codecs) are usually optimised for speech signals, and often operate at a fixed bit rate.

An audio codec can also be configured to operate with varying bit rates. At lower bit rates, such an audio codec may work with speech signals at a coding rate equivalent to pure speech codec. At higher bit rates, the performance may be good with any signal including music, background noise and speech.

A further audio coding option is an embedded variable rate speech or audio coding scheme, which is also referred as a layered coding scheme. Embedded variable rate audio or speech coding denotes an audio or speech coding scheme, in which a bit stream resulting from the coding operation is distributed into successive layers. A base or core layer which comprises of primary coded data generated by a core encoder is formed of the binary elements essential for the decoding of the binary stream, and determines a minimum quality of decoding. Subsequent layers make it possible to progressively improve the quality of the signal arising from the decoding operation, where each new layer brings new information. One of the particular features of layered based coding is the possibility offered of intervening at any level whatsoever of the transmission or storage chain, so as to delete a part of binary stream without having to include any particular indication to the decoder.

The decoder uses the binary information that it receives and produces a signal of corresponding quality. For instance International Telecommunications Union Technical (ITU-T) standardisation aims at a wideband codec of 50 to 7000 Hz with bit rates from 8 to 32 kbps. The codec core layer will either work at 8 kbps or 12 kbps, and additional layers with quite small granularity will increase the observed speech and audio quality. The proposed layers will have as a minimum target at least five bit rates of 8, 12, 16, 24 and 32 kbps available from the same embedded bit stream.

By the very nature of layered, or scalable, based coding schemes the structure of the codecs tend to be hierarchical in form, consisting of multiple coding stages. Typically different coding techniques are used for the core (or base) layer and the additional layers. The coding methods used in the additional layers are then used to either code those parts of the signal which have not been coded by previous layers, or to code a residual signal from the previous stage. The residual signal is formed by subtracting a synthetic signal i.e. a signal generated as a result of the previous stage from the original. By adopting this hierarchical approach a combination of coding methods make it possible to reduce the output to relatively low bit rates but retaining sufficient quality, whilst also producing good quality audio reproduction by using higher bit rates.

Typically techniques used for low bit rate coding do not perform well at higher bit rates and vice versa. This has resulted in structures using two different coding technologies. The codec core layer is typically a speech codec based on the Code Excited Linear Prediction (CELP) algorithm or a variant such as adaptive multi-rate (AMR) CELP and variable multi-rate (VMR) CELP.

Details of the AMR codec can be found in the 3GPP TS 26.090 technical specification, the AMR-WB codec 3GPP TS 26.190 technical specification, and the AMR-WB+ in the 3GPP TS 26.290 technical specification.

A similar scalable audio codec is the VMR-WB codec (Variable Multi-Rate Wide Band) was developed with regards to the CDMA 2000 communication system.

Details on the VMR-WB codec can be found in the 3GPP2 technical specification C.S0052-0. In a manner similar to the AMR family the source control VMR-WB audio codec also uses ACELP coding as a core coder.

However these higher level signals are not optimally coded. For example, the codec described in Ragot et al, “A 8-32 Kbit/s scalable wideband speech and audio coding candidate for ITU-T G729EV standardisation” published in Acoustics, Speech and Signal Processing 2006, ICASSP 2006 proceedings, 2006 IEEE International Conference Volume 1, page I-1 to I-4 describes scalable wideband audio coding.

A further example of an audio codec is from U.S. patent application published as number 2006/0036535. This audio codec describes where the number of coding bits per frequency parameter is selected dependent on the importance of the frequency. Thus parameters representing ‘more important’ frequencies are coded using more bits than the number of bits used to code ‘less important’ frequency parameters.

However the higher layers within the codec are not optimally processed. For example a fluctuation of the transmission bandwidth over which the signal is transmitted may cause the encoder to adjust the number of bits per second transmitted over the communications system. As the layers are designed to be separable the codec typically reacts by removing the highest layer signal values. As these values represent the higher frequency components of the signal this effectively strips the higher frequency components from the signal and may result in the received signal being perceived as being dull in comparison to the full signal.

In scalable layered audio codecs of such type it is normal practice to arrange the various coding layers in order of perceptual importance. Whereby the bits associated with the quantisation of the perceptually important frequencies, which is typically the lower frequencies, is assigned to a lower and therefore perceptually more important coding layer. Consequently where the channel or storage chain is constrained, the decoder may not receive all coding layers, and some of the higher coding layers, which are typically associated with the higher frequencies of the coded signal, may not be decoded.

### SUMMARY OF THE INVENTION

This invention proceeds from the consideration that embedded scalable or layered coding of audio signals has the undesired effect of removing higher frequency components from the decoded signal when the transmission or storage chain is constrained. This may have the effect of reducing the overall perceived quality of the decoded audio signal.

Embodiments of the present invention aim to address the above problem.

There is provided according to a first aspect of the present invention an encoder for encoding an audio signal, wherein the encoder is configured to: generate for a first time period of the audio signal a first encoded signal comprising a plurality of spectral values; and transpose at least one of the plurality of spectral values.

The encoder may be further configured to: determine at least one factor value, each factor value being mapped to at least one of the plurality of spectral values, and transpose the at least one of the plurality of spectral values dependent on the factor value.

The encoder is preferably configured to determine the at least one factor value dependent on at least one of: a predetermined value; a parameter dependent on the mapped at least one spectral value; a parameter dependent on the mapped at least one spectral value and at least one further spectral value.

The first encoded signal may comprise at least two groups, each group may comprise a plurality of spectral values, and wherein each factor preferably having a mapping to each group, and wherein the encoder is preferably configured to transpose a group of the spectral values dependent on the factor value.

The first encoded signal may comprise two groups, the first group may comprise odd indexed spectral values and the second group may comprise even indexed spectral values.

The encoder is preferably configured to transpose the first group of spectral values so that all of the first group spectral values precede the second group spectral values.

The encoder is preferably further configured to transpose the first group of spectral values so that all of the second group spectral values precede the first group spectral values.

The encoder is preferably configured to generate for a second time period of the audio signal a second encoded signal comprising a second plurality of spectral values, wherein the second encoded signal preferably comprises two further groups, the first further group preferably comprising odd indexed spectral values of the second encoded signal and the second further group preferably comprising even indexed spectral values of the second encoded signal, wherein the encoder is preferably configured to transpose the first further group of spectral values so that a transposed second encoded signal comprises all of the first further group spectral values preceding the second further group spectral values when the first time period transposed signal comprises all of the second group spectral values preceding the first group spectral values, and the encoder is preferably configured to transpose the first further group of spectral values so that a transposed second encoded signal comprises all of the second further group spectral values preceding the first further group spectral values when the first time period transposed signal comprises all of the first group spectral values preceding the second group spectral values.

The encoder is preferably configured to transpose at least one of the plurality of spectral values at least twice.

According to a second aspect of the invention there is provided a method for encoding an audio signal comprising: generating for a first time period of the audio signal a first encoded signal comprising a plurality of spectral values; and transposing at least one of the plurality of spectral values.

The method for encoding may further comprise: determining at least one factor value, each factor value being mapped to at least one of the plurality of spectral values, wherein transposing preferably comprises transposing the at least one of the plurality of spectral values dependent on the factor value.

Determining preferably comprises determining the at least one factor value dependent on at least one of: a predetermined value; a parameter dependent on the mapped at least one spectral value; a parameter dependent on the mapped at least one spectral value and at least one further spectral value.

The first encoded signal may comprise at least two groups, each group may comprise a plurality of spectral values, and wherein each factor is preferably mapped to each group, and wherein transposing may comprise transposing a group of the spectral values dependent on the factor value.

The first encoded signal may comprise two groups, the first group may comprise odd indexed spectral values and the second group may comprise even indexed spectral values.

Transposing may comprise transposing the first group of spectral values so that all of the first group spectral values precede the second group spectral values.

Transposing may comprise transposing the first group of spectral values so that all of the second group spectral values precede the first group spectral values.

The method may further comprise: generating for a second time period of the audio signal a second encoded signal comprising a second plurality of spectral values, wherein the second encoded signal may comprise two further groups, the first further group may comprise odd indexed spectral values of the second encoded signal and the second further group may comprise even indexed spectral values of the second encoded signal, transposing the first further group of spectral values such that a transposed second encoded signal comprises all of the first further group spectral values preceding the second further group spectral values when all of the second group spectral values precede the first group spectral values, and transposing the first further group of spectral values such that a transposed second encoded signal comprises all of the second further group spectral values preceding the first further group spectral values when the all of the first group spectral values precede the second group spectral values.

The method for encoding may further comprise transposing at least one of the plurality of the transposed spectral values.

According to a third aspect of the present invention there is provided a decoder for decoding an encoded audio signal, wherein the decoder is configured to: receive for a first time period of an audio signal a first encoded signal comprising a plurality of spectral values; and transpose at least one of the plurality of spectral values.

The decoder is preferably further configured to: determine at least one factor value, each factor value being mapped to at least one of the plurality of spectral values, and transpose the at least one of the plurality of spectral values dependent on the factor value.

The decoder is preferably configured to determine the at least one factor value dependent on at least one of: a predetermined value; a parameter dependent on the mapped at least one spectral value; a parameter dependent on the mapped at least one spectral value and at least one further spectral value.

The first encoded signal may comprise at least two groups, each group may comprise a plurality of spectral values, and wherein each factor may have a mapping to each group, wherein the decoder is preferably configured to transpose a group of the spectral values dependent on the factor value.

The first encoded signal may comprise two groups, the first group may comprise a preceding half of the spectral values and the second group may comprise the remainder spectral values.

The decoder is preferably configured to transpose the first group of spectral values such that the first group are transposed as the odd indexed spectral values, and the second group are the even indexed spectral values.

The decoder is preferably configured to transpose the first group of spectral values such that the first group are transposed as the even indexed spectral values, and the second group are the odd indexed spectral values.

The decoder is preferably configured to receive for a second time period of the audio signal a second encoded signal preferably comprising a second plurality of spectral values, wherein the second encoded signal preferably comprises two further groups, the first further group preferably comprising a preceding half of the spectral values and the second further group preferably comprising the remainder spectral values, wherein the decoder is preferably configured to transpose the first further group of spectral values such that the first further group are transposed as the odd indexed spectral values, and the second further group are the even indexed spectral values when the first time period transposed signal preferably comprises the first group as the even indexed spectral values, and the second group are the odd indexed spectral values, and the decoder is preferably configured to transpose the first further group of spectral values such that the first further group are transposed as the even indexed spectral values, and the second further group are the odd indexed spectral values when the first time period transposed signal preferably comprises the first group as the even indexed spectral values, and the second group are the odd indexed spectral values.

The decoder is preferably configured to transpose at least one of the plurality of spectral values at least twice.

According to a fourth aspect of the invention there is provided a method for decoding an encoded audio signal, comprising: receiving for a first time period of an audio signal a first encoded signal comprising a plurality of spectral values; and transposing at least one of the plurality of spectral values.

The method for decoding may further comprise determining at least one factor value, each factor value being mapped to at least one of the plurality of spectral values, and transposing may comprise transposing the at least one of the plurality of spectral values dependent on the factor value.

Determining may comprise determining the at least one factor value dependent on at least one of: a predetermined value; a parameter dependent on the mapped at least one spectral value; a parameter dependent on the mapped at least one spectral value and at least one further spectral value.

The first encoded signal may comprise at least two groups, each group may comprise a plurality of spectral values, and wherein each factor may have a mapping to each group, transposing may comprise transposing a group of the spectral values dependent on the factor value.

The first encoded signal may comprise two groups, the first group may comprise second group may comprise the remainder spectral values.

Transposing may comprise transposing the first group of spectral values such that the first group are transposed as the odd indexed spectral, and the second group are the even indexed spectral values.

Transposing may comprise transposing the first group of spectral values such that the first group are transposed as the even indexed spectral values, and the second group are the odd indexed spectral values.

The method for decoding may comprise receiving for a second time period of the audio signal a second encoded signal preferably comprising a second plurality of spectral values, wherein the second encoded signal preferably comprises two further groups, further group preferably comprises a preceding half of the spectral values and the second group preferably comprises the remainder spectral values, further transposing the first further group of spectral values such that the first further group are transposed as the odd indexed spectral values, and the second further group are the even indexed spectral values when the first time period transposed signal may comprise the first group as the even indexed spectral values, and the second group are the odd indexed spectral values, and may further transpose the first further group of spectral values such that the first further group are transposed as the even indexed spectral values, and the second further group are the odd indexed spectral values when the first time period transposed signal comprises the first group as the even indexed spectral values, and the second group are the odd indexed spectral values.

The method for decoding may further comprise transposing at least one of the plurality of the transposed spectral values.

According to a fifth aspect of the invention there is provided an apparatus comprising an encoder as described above.

According to a sixth aspect of the invention there is provided an apparatus comprising a decoder as described above.

According to a seventh aspect of the invention there is provided a computer program product configured to perform a method for encoding an audio signal comprising: generating for a first time period of the audio signal a first encoded signal comprising: a plurality of spectral values; and transposing at least one of the plurality of spectral values.

According to an eighth aspect of the invention there is provided a computer program product configured to perform a method for decoding an encoded audio signal; comprising: receiving for a first time period of an audio signal a first encoded signal comprising a plurality of spectral values; and transposing at least one of the plurality of spectral values.

According to a ninth aspect of the invention there is provided an encoder for encoding an audio signal, wherein the encoder comprises: means for generating for a first time period of the audio signal a first encoded signal comprising a plurality of spectral values; and means for transposing at least one of the plurality of spectral values.

According to a tenth aspect of the invention there is provided a decoder for decoding an encoded audio signal, comprising: means for receiving for a first time period of an audio signal a first encoded signal comprising a plurality of spectral values; and means for transposing at least one of the plurality of spectral values.

According to a eleventh aspect of the invention there is provided an electronic device comprising an encoder as described above.

According to a twelfth aspect of the invention there is provided an electronic device comprising a decoder as described above.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2a shows schematically an audio encoder employing an embodiment of the present invention;

FIG. 2b shows schematically a part of the audio encoder shown in FIG. 2a;

FIG. 3a shows a flow diagram illustrating the operation of the audio encoder according to an embodiment of the present invention;

FIG. 3b shows a flow diagram illustrating part of the operation of the audio encoder shown in FIG. 3a;

FIG. 4a shows schematically an audio decoder according to an embodiment of the present invention;

FIG. 4b shows schematically a part of the audio decoder shown in FIG. 4a;

FIG. 5a shows a flow diagram illustrating the operation of an embodiment of the audio decoder according to the present invention; and

FIG. 5b shows a flow diagram illustrating part of the operation shown in FIG. 5a.

### DESCRIPTION OF PREFERRED EMBODIMENTS OF THE INVENTION

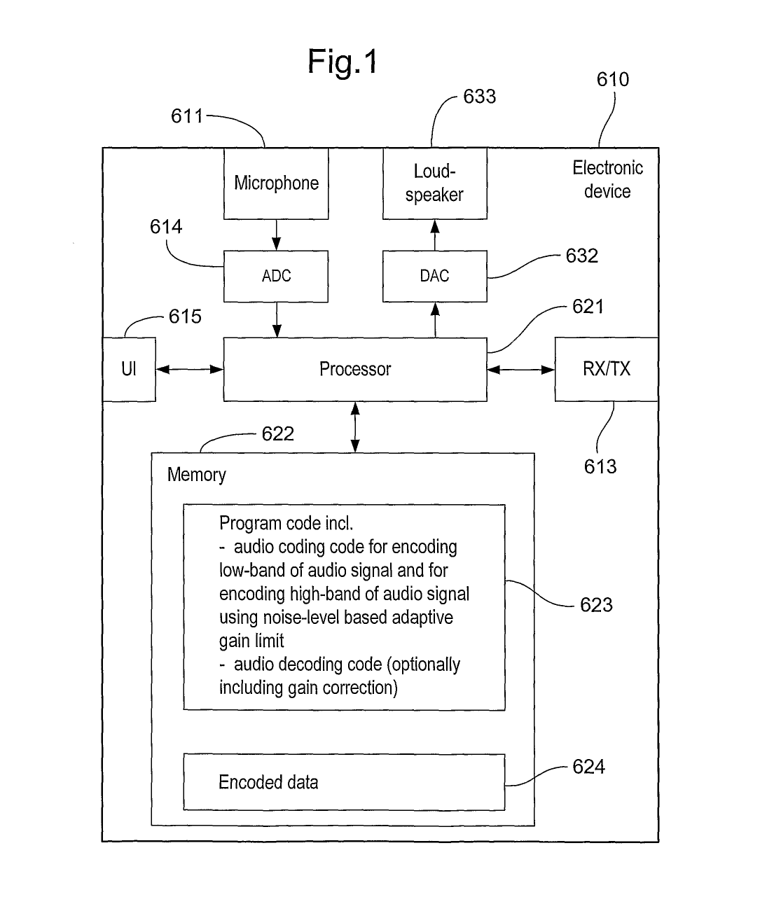

The following describes in more detail possible codec mechanisms for the provision of layered or scalable variable rate audio codecs. In this regard reference is first made to FIG. 1 schematic block diagram of an exemplary electronic device 610, which may incorporate a codec according to an embodiment of the invention.

The electronic device 610 may for example be a mobile terminal or user equipment of a wireless communication system.

The electronic device 610 comprises a microphone 611, which is linked via an analogue-to-digital converter 614 to a processor 621. The processor 621 is further linked via a digital-to-analogue converter 632 to loudspeakers 633. The processor 621 is further linked to a transceiver (TX/RX) 613, to a user interface (UI) 615 and to a memory 622.

The processor 621 may be configured to execute various program codes. The implemented program codes comprise an audio encoding code for encoding a lower frequency band of an audio signal and a higher frequency band of an audio signal. The implemented program codes 623 further comprise an audio decoding code. The implemented program codes 623 may be stored for example in the memory 622 for retrieval by the processor 621 whenever needed. The memory 622 could further provide a section 624 for storing data, for example data that has been encoded in accordance with the invention.

The encoding and decoding code may in embodiments of the invention be implemented in hardware or firmware.

The user interface 615 enables a user to input commands to the electronic device 610, for example via a keypad, and/or to obtain information from the electronic device 610, for example via a display. The transceiver 613 enables a communication with other electronic devices, for example via a wireless communication network.

It is to be understood again that the structure of the electronic device 610 could be supplemented and varied in many ways.

A user of the electronic device 610 may use the microphone 611 for inputting speech that is to be transmitted to some other electronic device or that is to be stored in the data section 624 of the memory 622. A corresponding application has been activated to this end by the user via the user interface 615. This application, which may be run by the processor 621, causes the processor 621 to execute the encoding code stored in the memory 622.

The analogue-to-digital converter 614 converts the input analogue audio signal into a digital audio signal and provides the digital audio signal to the processor 621.

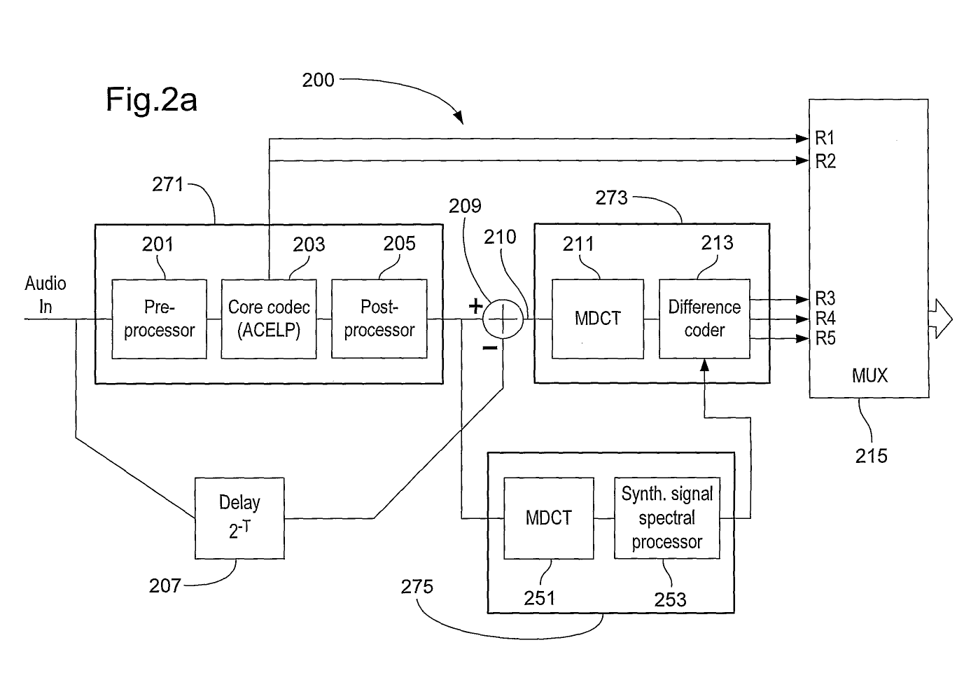

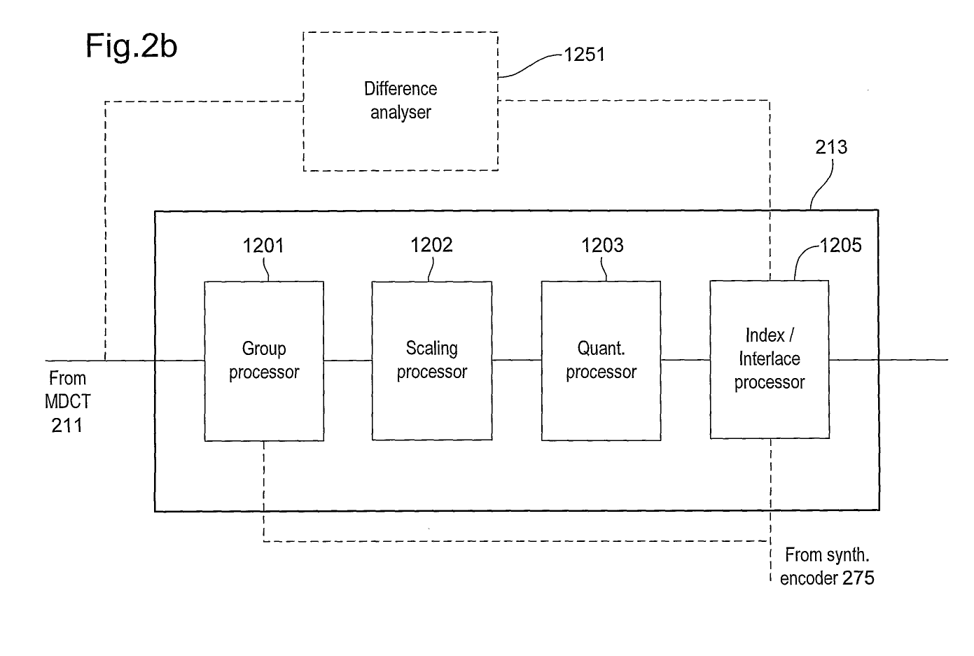

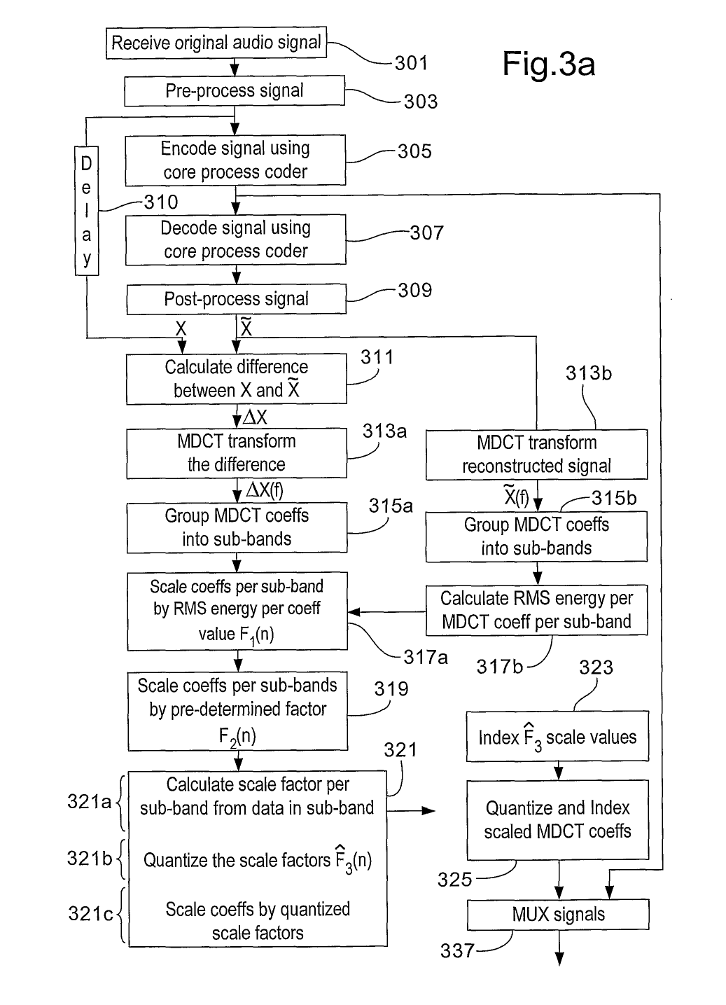

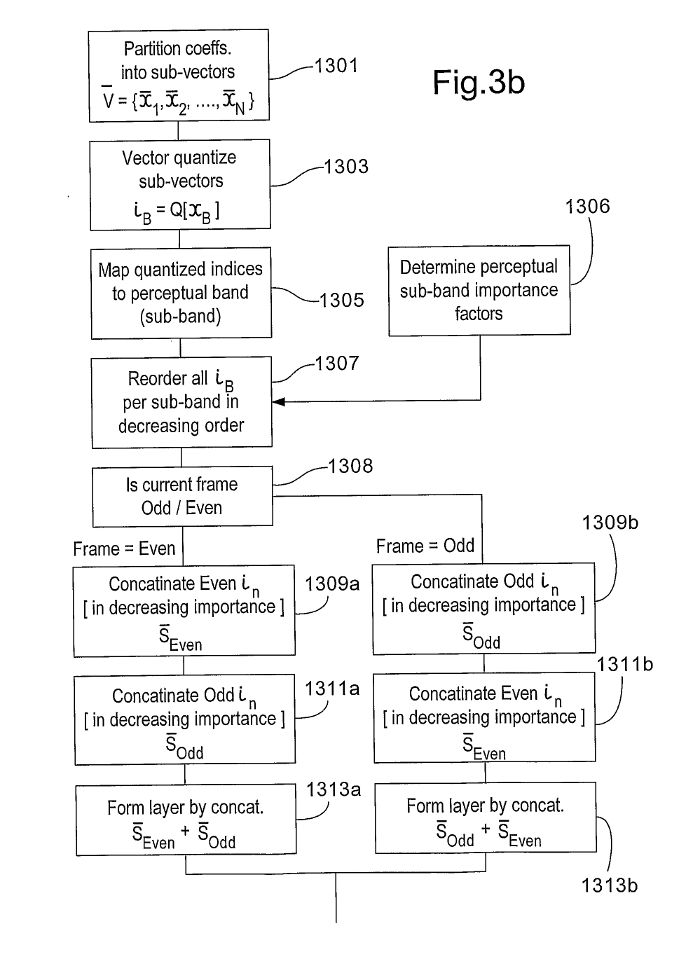

The processor 621 may then process the digital audio signal in the same way as described with reference to FIGS. 2 and 3.

The resulting bit stream is provided to the transceiver 613 for transmission to another electronic device. Alternatively, the coded data could be stored in the data section 624 of the memory 622, for instance for a later transmission or for a later presentation by the same electronic device 610.

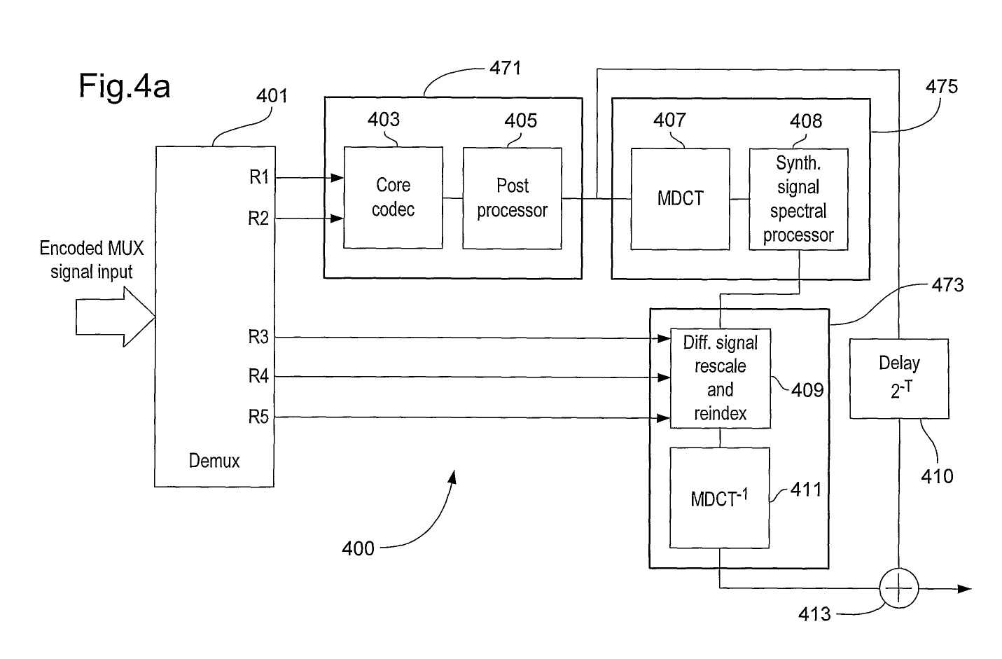

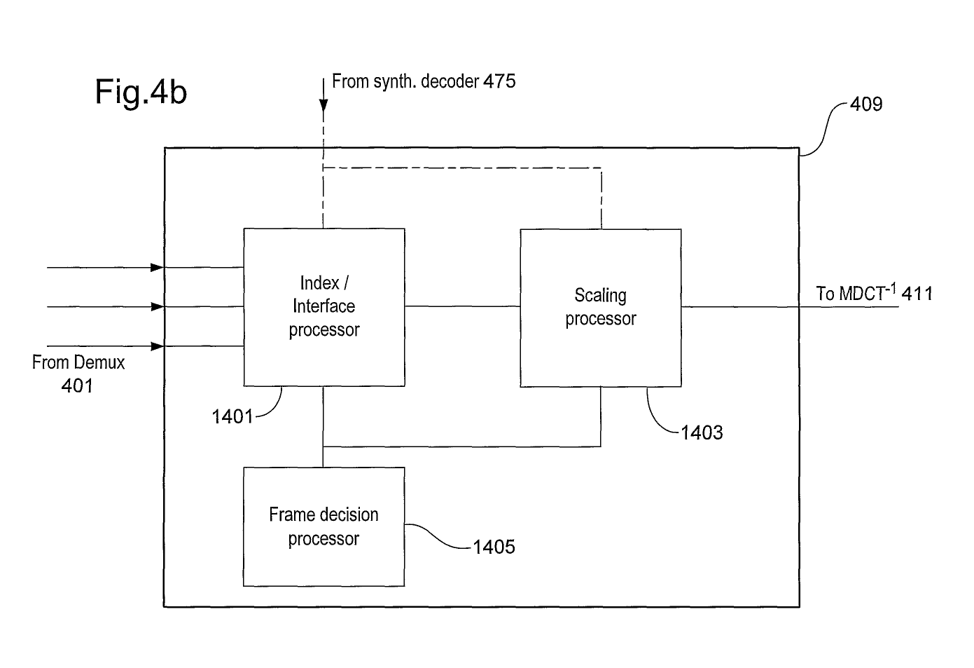

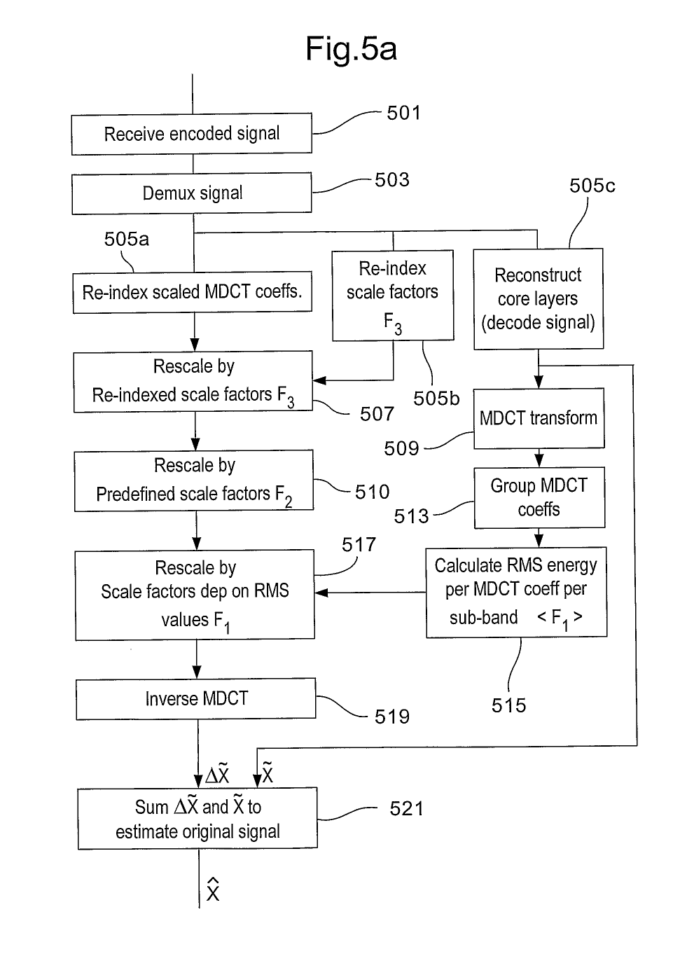

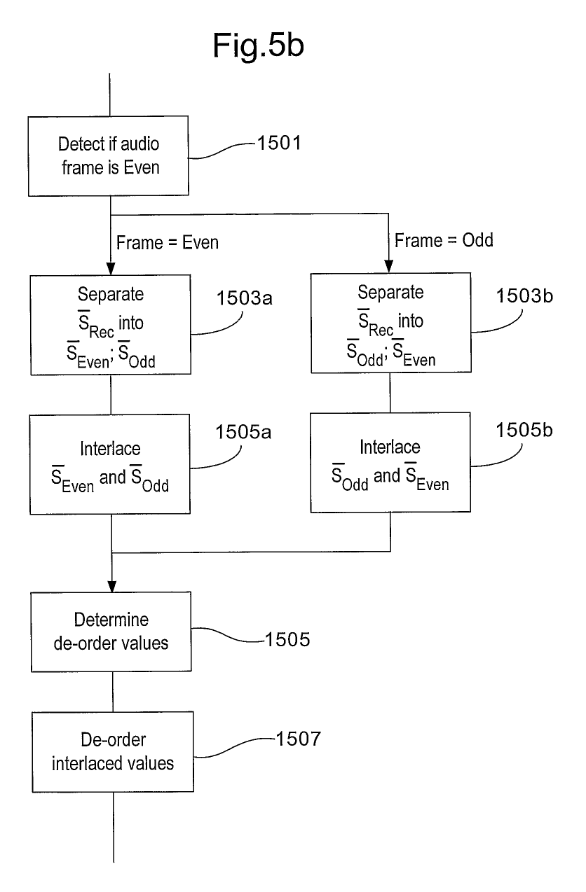

The electronic device 610 could also receive a bit stream with correspondingly encoded data from another electronic device via its transceiver 613. In this case, the processor 621 may execute the decoding program code stored in the memory 622. The processor 621 decodes the received data, for instance in the same way as described with reference to FIGS. 4 and 5, and provides the decoded data to the digital-to-analogue converter 632. The digital-to-analogue converter 632 converts the digital decoded data into analogue audio data and outputs them via the loudspeakers 633. Execution of the decoding program code could be triggered as well by an application that has been called by the user via the user interface 615.

The received encoded data could also be stored instead of an immediate presentation via the loudspeakers 633 in the data section 624 of the memory 622, for instance for enabling a later presentation or a forwarding to still another electronic device.

It would be appreciated that the schematic structures described in FIGS. 2 and 4 and the method steps in FIGS. 3 and 5 represent only a part of the operation of a complete audio codec as exemplarily shown implemented in the electronic device shown in FIG. 1. The general operation of audio codecs is known and features of such codecs which do not assist in the understanding of the operation of the invention are not described in detail.

The embodiment of the invention audio codec is now described in more detail with respect to FIGS. 2 to 5.

With respect to FIGS. 2a, 2b, 3a, and 3b a view of an encoder (otherwise known as the coder) embodiment of the invention is.

With respect to FIG. 2a a schematic view of the encoder 200 implementing an embodiment of the invention is shown. Furthermore the operation of the embodiment encoder is described as a flow diagram in FIG. 3a.

The encoder may be divided into: a core encoder 271; a delay unit 207; a difference unit 209; a difference encoder 273; a difference encoder controller 275; and a multiplexer 215.

The encoder 200 in step 301 receives the original audio signal. In a first embodiment of the invention the audio signal is a digitally sampled signal. In other embodiments of the present invention the audio input may be an analogue audio signal, for example from a microphone 6, which is analogue to digitally (A/D) converted. In further embodiments of the invention the audio input is converted from a pulse code modulation digital signal to amplitude modulation digital signal. The core encoder 271, receives the audio signal to be encoded and outputs the encoded parameters which represent the core level encoded signal, and also the synthesised audio signal (in other words the audio signal is encoded into parameters and then the parameters are decoded using the reciprocal process to produce the synthesised audio signal). In the embodiment shown in FIG. 2a the core encoder 271 may be divided into three parts (the pre-processor 201, core codec 203 and post-processor 205).

In the embodiment shown in FIG. 2a, the core encoder receives the audio input at the pre-processing element 201. The pre-processing stage 201 may perform a low pass filter followed by decimation in order to reduce the number of samples being coded. For example, if the input signal was originally sampled at 16 kHz, the signal may be down-sampled to 8 kHz using a linear phase FIR filter with a 3 decibel cut off around 3.6 kHz and then decimating the number of samples by a factor of 2. The pre-processing element 201 outputs a pre-processed audio input signal to the core codec 203. This operation is represented in step 303 of FIG. 3a. Further embodiments may include core codecs operating at different sampling frequencies. For instance some core codecs can operate at the original sampling frequency of the input audio signal.

The core codec 203 receives the signal and may use any appropriate encoding technique. In the embodiment shown in FIG. 2a the core codec is an algebraic code excited linear prediction encoder (ACELP) which is configured to a bitstream of typical ACELP parameters as lower level signals as depicted by R1 or/and R2. The parameter bitstream is output to the multiplexer 215.

If ACELP is used, the encoder output bit stream may include typical ACELP encoder parameters. Non-limiting examples of these parameters include LPC (Linear prediction calculation) parameters quantized in LSP (Line Spectral Pair) or ISP (Immittance Spectral Pair) domain describing the spectral content, LTP (long-term prediction) parameters describing the periodic structure, ACELP excitation parameters describing the residual signal after linear predictors, and signal gain parameters.

The core codec 203 may, in some embodiments of the present invention, comprise a configured two-stage cascade code excited linear prediction (CELP) coder, such as VMR, producing R1 and/or R2 bitstreams at 8 Kbit/s and/or 12 Kbit/s respectively. In some embodiments of the invention it is possible to have a single speech coding stage, such as G729—defined by the ITU-T standard. It is to be understood that embodiments of the present invention could equally use any audio or speech based codec to represent the core layer.

Although the above embodiments have been described as producing core levels or layers described above as the R1 and R2 layers, it is to be understood that further embodiments may adopt differing number of core encoding layers, thereby being capable of achieving different levels of granularity in terms of both bit rate and audio quality.

This encoding of the pre-processed signal is shown in FIG. 3a by step 305.

The core codec 203 furthermore outputs a synthesised audio signal (in order words the audio signal is first encoded into parameters such as those described above and then decoded back into an audio signal within the same call codec). This synthesised signal is passed to the post-processing unit 205. It is appreciated that the synthesised signal is different from the signal input to the core codec as the parameters are approximations to the correct values—the differences are because of the modelling errors and quantisation of the parameters.

The decoding of the parameters is shown in FIG. 3a by step 307.

The post-processor 205 re-samples the synthesised audio output in order that the output of the post-processor has a sample rate equal to the input audio signal. Thus, using the example values described above with respect to the pre-processor 201 and the core codec 203, the synthesised signal output from the core codec 203 is first up-sampled to 16 kHz and then filtered using a low path filter to prevent aliasing occurring.

The post processing of the synthesized signal is shown in FIG. 3a by step 309.

The post-processor 205 outputs the re-sampled signal to the difference unit 209.

In some embodiments of the invention the pre-processor 201 and post-processor 205 are optional elements and the core codec may receive and encode the digital signal directly. In some embodiments of the invention the core codec 203 receives an analogue or pulse width modulated signal directly and performs the parametization of the audio signal outputting a synthesized signal to the difference unit 209.

The audio input is also passed to the delay unit 207, which performs a digital delay equal to the delay produced by the core coder 271 in producing a synthesized signal, and then outputs the signal to the difference unit 209 so that the sample output by the delay unit 207 to the difference unit 209 is the same indexed sample as the synthesized signal output from the core coder 271 to the difference unit 209. In other words a state of time alignment is achieved.

The delay of the audio signal is shown in FIG. 3a by step 310.

The difference unit 209 calculates the difference between the input audio signal, which has been delayed by the delay unit 207, and the synthesised signal output from the core encoder 271. The difference unit outputs the difference signal to the difference encoder 273.

The calculation of the difference between the delayed audio signal and the synthesized signal is shown in FIG. 3a by step 311.

The difference encoder 273 comprises a modified discrete cosine transform (MDCT) processor 211 and a difference coder 213.

The difference encoder receives the difference signal at the modified discrete cosine transform processor 211. The modified discrete cosine transform processor 211 receives the difference signal and performs a modified discrete cosine transform (MDCT) on the signal. The MDCT is a Fourier-related transform based on the type-IV discrete cosine transform (DCT-IV), with the additional property of being lapped. The transform is designed to be performed on consecutive blocks of a larger dataset, where subsequent blocks are overlapped so that the last half of one block coincides with the first half of the next block. This overlapping, in addition to the energy-compaction qualities of the DCT, makes the MDCT especially attractive for signal compression applications, since it can remove time aliasing components which is a result of the finite windowing process.

It is to be understood that further embodiments may equally generate the difference signal within a frequency domain. For instance, the original signal and the core codec synthetic signal can be transformed into the frequency domain. The difference signal can then be generated by subtracting corresponding frequency coefficients.

It is to be further understood that embodiments of the present invention may generate the time to frequency transformation (and vice versa) by any discrete orthogonal transform. Wherein, the coefficients of the forward transform are given by the weighting factor of each orthogonal basis function.

The MDCT processing of the difference signal is shown in FIG. 3a by step 313a.

The difference coder may encode the components of the difference signal as a sequence of higher coding layers, where each layer may encode the signal at a progressively higher bit rate and quality level. In FIG. 2, this is depicted by the encoding layers R3, R4 and/or R5. It is to be understood that further embodiments may adopt differing number of encoding layers, thereby achieving a different level of granularity in terms of both bit rate and audio quality.

The output of the modified discrete cosine transform processor 211 is passed to the difference coder 213. The difference coder 213 is shown in further detail in FIG. 2b.

The difference coder 213 receives the MDCT coefficients output from the MDCT processor 211 and a grouping processor processes the coefficients into groups of coefficients (these groups of coefficients are also known as sub-bands or perceptual bands).

Table 1, below, represents an example of grouping of coefficients which may be carried out according to a first embodiment of the invention.

Table 1 shows a grouping of the frequency coefficients according to a psycho-acoustical model. In this example each ‘frame’ of the difference signal (20 ms) when applied to the MDCT produces 280 critically sampled coefficient values. However it would be appreciated that depending on the number of samples input the MDCT may output different numbers of coefficients per transform. Similarly table 1 represents only one non-limiting example of grouping the coefficients into groups of coefficients and that embodiments of the present invention may group the coefficients in other combinations.

In the example provided by Table 1, the first column represents the index of the sub-band or group, the second column represents the starting coefficient index value from the MDCT unit, and the third column represents the length of the sub-band or group as a number of consecutive coefficients.

Thus, for example, Table 1 indicates that there are 280 coefficients in total with the first sub-band (the sub-band with an index 1) starting from coefficient 0 (the first coefficient and is 4 coefficients in length and the 21st sub-band (index 21) starts from coefficient 236 and is 44 coefficients in length.

TABLE 1

| Sub band | Starting | Sub band |
|---|---|---|
| index | coefficient | length |
| 1 | 0 | 4 |
| 2 | 4 | 4 |
| 3 | 8 | 4 |
| 4 | 12 | 4 |
| 5 | 16 | 4 |
| 6 | 20 | 4 |
| 7 | 24 | 6 |
| 8 | 30 | 6 |
| 9 | 36 | 6 |
| 10 | 42 | 6 |
| 11 | 48 | 8 |
| 12 | 56 | 8 |
| 13 | 64 | 12 |
| 14 | 76 | 12 |
| 15 | 88 | 12 |
| 16 | 100 | 24 |
| 17 | 124 | 24 |
| 18 | 148 | 24 |
| 19 | 172 | 24 |
| 20 | 196 | 30 |
| 21 | 236 | 44 |

The grouping of the coefficients into sub-bands is shown in FIG. 3a by step 315a.

These groups are then passed to the scaling processor 1202. The difference coder 213 scaling processor 1202 is configured to process the grouped coefficient values in order to scale the coefficient values so when the signals are quantized as little information is discarded as possible. Three examples of possible scaling processes are described below, however it would be appreciated that other scaling processes may be implemented (together with their appropriate rescaling processes in the decoder as described below).

The scaling processor 1202 may perform a correlation related scaling on the coefficient values. The calculation of the determination of the factors used to scale the coefficient values is generated from the values output from the synthesized signal processor 275, which is described in further detail below.

The synthesized scaling of the coefficients is shown in FIG. 3a by step 317a.

The scaling processor 1202 may perform a predetermined scaling on the coefficient values. This predetermined value is known to both encoder 200 and decoder 400 of the codec.

The predetermined scaling of the coefficients is shown in FIG. 3a by step 319.

The scaling processor 1202 may perform a sub-band factor scaling of the coefficients.

The sub-band scaling of the coefficients is shown in FIG. 3a by step 321.

The scaling processor 1202 may in performing a sub-band factor scaling first determinate the scale factor per sub-band from data in each sub-band. For example the scaling processor 1202 may determine the energy per sub-band of the difference signal in order to calculate a scaling factor based on the value of the energy per sub-band.

This calculation step is shown in FIG. 3a by step 321a.

The scaling processor 1202 may quantize the scale factors. The quantization of the scale factors may be performed using a 5 codeword quantizer. In such examples one codebook may be used for each sub band.

This quantization of the factors is shown in FIG. 3a by step 321b.

The scaling processor 1202 furthermore scales the sub-band coefficients according to the quantized scale factors.

This scaling by the quantized scale factors is shown in FIG. 3a by step 321c.

The scaled coefficients are passed to the quantization processor 1203.

The quantization processor 1203 performs a quantization of the scaled coefficients. The quantization of the coefficients and the indexing of the quantized coefficients is shown in FIG. 3a by step 325.

For completeness a detailed example of the quantisation process is described below. It is to be understood that other quantisation processes known in the art may be used, including inter alia, vector quantisation.

In this example the MDCT coefficients corresponding to frequencies from 0 to 7000 Hz are quantized, the rest being set to zero. As described above the sampling frequency in this example is 16 kHz (as described above), this corresponds to having to quantize 280 coefficients for each frame of 20 ms. The quantization may be performed with 4 dimensional quantizers, so that the 280 length vector is divided into 70 4-dimensional vectors which are independently quantized.

The quantization processor 1203 may partition the coefficient vector v into sub-vectors x₁, x₂, x₃, x_{N}. This partitioning of the coefficient vector is shown in FIG. 3b in step 1301.

The quantization processor 1203 may vector quantize the subvectors. The codebook used for the quantization of each of the 70 vectors depends on the number of bits allocated to it. An embedded codebook like the one in Table 2 could be used.

TABLE 2

| | | | | | Cardi- | | Cumulated | |
|---|---|---|---|---|---|---|---|---|
| No. | Leader vector | | | | nality | Obs. | no. bits | |
| 1 | 0 | 0 | 0 | 0 | 1 | | 0 | Codebook |
| | | | | | | | | 0 bits |
| 2 | 1 | 0 | 0 | 0 | 8 | | 4 | |
| 3 | 0.7 | 0 | 0 | 0 | 7 | incomplete | 4 | Codebook |
| | | | | | | | | 4 bits |
| 4 | 1 | 1 | 0 | 0 | 12 | parity 1 | 5 | |
| 5 | 1 | 1 | 1 | 0 | 32 | | 6 | Codebook |
| | | | | | | | | 6 bits |
| 6 | 1 | 0.7 | 0 | 0 | 48 | | 7 | |
| 7 | 1 | 1 | 1 | 1 | 16 | | 7 | Codebook |
| | | | | | | | | 7 bits |

The codevectors are obtained as signed permutations of the leader vectors from Table 2. From the leader vector 3 only 7 signed permutations are considered, the eighth one being mapped to the leader vector 2 (the value+/−0.7 is changed to +/−1). The parity of the leader vector 4 may be equal to one, so that the number of negative signs in the codevectors may be even. For a parity value of −1, the number of negative components of the codevectors should be odd and for a null parity value, there are no constraints on the signs of the codevector components.

In embodiments of the invention there may be several bit allocation arrangements. For example, the number of bits allocated for each of the 70 vectors may be in order from lower frequency to higher frequency coefficients:

{7,7,7,7,7,7,7,7,6,6,6,6,6,6,6,6,6,6,6,6,6,4,4,4,4,4,4,4,4,4,4,4,4,4,4,4,4,4,4,4,4,4,4,4, 4,4,4,4,4,4,0,4,4,4,4,4,4,4,4,4,4,4,4,4,4,4,4,4,4,4} or

{6,6,6,6,6,6,6,6,6,6,6,4,6,4,6,4,6,4,6,4,6,4,6,4,6,4,6,4,6,4,6,4,6,4,6,4,6,4,6,4,4,4,4,4, 4,4,4,4,4,4,0,4,4,4,4,4,4,4,4,4,4,4,4,4,4,4,4,4,4,4}.

The choice of the bit allocation may be made based on an analysis of the energy of the original signal, or on the synthesized signal, or equally made as a predetermined decision.

The nearest neighbour search algorithm may be performed according to the search on leaders algorithm known in the art.

An example of the indexing of the codevectors (the quantised coefficients) is described here. In this example a distinction may be made between an index issued from the position of the non-null codevector components Iₚₒₛ, and an index issued from the signs of the non-null components, I_{B}.

In order to obtain Iₚₒₛ, the input of the enumeration algorithm may be for example the vector v={x₁, x₂, x₃, x_{N}} (n=4) such that there are exactly M unitary components in the vector, at positions corresponding to the positions of non-null components in the codevector. Additionally, a position vector p=(p₀, . . . , p_{M-1})ε{0, . . . , n−1}^{M} is created, which specifies the exact location of each non-null component. Since there are

$$( \begin{matrix}n \\ M\end{matrix} )$$

for such v vectors, they can be enumerated like binomial coefficients following the algorithm given by equations:

$${I}_{pos} ( n , M , p ) = {\sum }_{i = 1}^{{p}_{0}} ( \begin{matrix}n - i \\ M - 1\end{matrix} ) + {I}_{pos} ( \begin{matrix}n - {p}_{0} - 1 , \\ M - 1 , \\ ( \begin{matrix}{p}_{1} , … , \\ {p}_{M - 1}\end{matrix} ) - {p}_{0} - 1\end{matrix} )$$

$$and$$

$${I}_{pos} ( {n}^{′} , 1 , [ i ] ) = i , 0 \leq i < {n}^{′} \leq n .$$

The index I_{B} is obtained such that its binary representation of M bits may include a ‘zero’ bit for a negative valued component and a ‘one’ bit for each positive valued component.

The index I_{B} is calculated then as:

$${I}_{B} = {\sum }_{i = 1}^{S} {b}_{i} {2}^{i - 1} ,$$

where bᵢ is 0 if the i-th non-null component is negative and 1 otherwise.

The final index I of the codevector is calculated using I=Iₚₒₛ2^{M}+I_{B}.

This example may be applied the leader vectors 2, 3, 4, 5, 7. The leader vector 1 describes a single vector. For the leader vector 6, a supplementary offset of

$${2}^{2} ( \begin{matrix}4 \\ 2\end{matrix} ) = 24$$

may be added to the index of the codevectors for which the value+/−0.7 is before the value+/−1.

This vector quantization process is shown in FIG. 3b by step 1303.

The quantization processor 1203, then passes the indexed quantized coefficient values, and may also pass the indexed quantized scaling factors, and other indicators to the Index/interlace processor 1205.

The Index/interlace processor 1205 may map each quantized value to a sub-band. This mapping of quantized value (vector) to a sub-band is shown in FIG. 3b in step 1305.

The Index/interlace processor 1205 may also determine in each perceptual sub-band a series of importance factors representing the importance of each frequency coefficient value in the sub-band. This may in some embodiments be carried out based on a pre-determined psycho-acoustical modelling of the spectrum of sub-bands, which produces pre-determined importance factors. For example it may be determined that specific coefficient indices (sub-vectors) in specific sub-bands are typically more dominant than others and thus these sub-bands and/or sub-vectors are determined to have a relatively high importance factor over a less dominant sub-band and/or sub-vector.

In other embodiments of the present invention the sub-band index importance factors may be dynamically determined. Thus the index/interlace processor 1205 may determine the importance factors dependent on a received parameter related to each sub-band index.

These parameters may be calculated from the difference signal coefficients and, for example, provided from the difference analyser 1251. In other embodiments of the invention these parameters may be calculated from the synthesized signal coefficients, for example these parameters may be any of the parameters provided from the synthesized signal encoder 275 for example the energy of each coefficient of each sub-band. In further embodiments of the invention these parameters may also be calculated from the original audio signal.

Each of the importance factors may be determined based on a single received frequency coefficient parameter or may be determined based on a combination of frequency coefficient parameters. For example modelling a psycho-acoustical masking effect may be performed by comparing the energy of the frequency coefficient index with neighbouring frequency coefficient indices.

This determination of the perceptual sub-band importance factor is shown in FIG. 3b in step 1306.

The Index/interlace processor 1205 may use the importance factors to re-order all of the vectors I_{B} per sub-band in decreasing order (or in other embodiments in increasing order). Thus within each sub-band the indices are arranged in order of determined importance and the importance factor determines the index position of the sub-band values following a re-ordering.

The re-ordering of indices is shown in FIG. 3b in step 1307.

The Index/interlace processor 1205 may then determine whether the current frame is an odd numbered frame or an even numbered frame. This is shown in FIG. 3b in step 1308.

If the frame is an even numbered frame:

The Index/interlace processor 1205 may select and concatenate the even indexed vectors I_{B} in order of decreasing importance to form the vector Sₑᵥₑₙ. This even vector concatenation is shown in FIG. 3b in step 1309a.

The Index/interlace processor 1205 may select and concatenate the odd indexed vectors I_{B} in order of decreasing importance to form the vector S_{odd}. This odd vector concatenation is shown in FIG. 3b in step 1311a.

The Index/interlace processor 1205 may form a layer by concatenating the even vector with the odd vector, i.e. S_{layer}={Sₑᵥₑₙ;S_{odd}}. Where S_{layer} may be any higher layer of encoding, that is R3, R4, or/and R5. However the embodiment may achieve a better level of performance if the highest R5 layer is chosen for encoding. The layer formation concatenation is shown in FIG. 3b in step 1313a.

If the frame is an odd numbered frame:

The Index/interlace processor 1205 may select and concatenate the odd indexed vectors I_{B} in order of decreasing importance to form the vector S_{odd}. This odd vector concatenation is shown in FIG. 3b in step 1309b.

The Index/interlace processor 1205 may select and concatenate the even indexed vectors I_{B} in order of decreasing importance to form the vector Sₑᵥₑₙ. This even vector concatenation is shown in FIG. 3b in step 1311b.

The Index/interlace processor 1205 may form a layer by concatenating the even vector with the odd vector, i.e. S_{layer}={S_{odd};Sₑᵥₑₙ}. This layer formation concatenation is shown in FIG. 3b in step 1313b.

Although index/interlace processor 1205 in the above example describes the performance of a determination, re-ordering and an interlacing, it would be appreciated that in embodiments of the present invention a determination and re-ordering or a interlacing only may be carried out in order to produce at least a partial improvement over the problem described above.

Furthermore the interlacing of the sub-vectors may be considered to be a re-ordering of the sub-vectors wherein the re-ordering using a predefined importance factor determination. The example described above may be considered to be two independent re-ordering processes. The first re-ordering process is dependent on a determined importance factor. The second re-ordering (the interlacing process) dependent on a further set of importance factors. The importance factors as described above indicate the index position of each value following the re-ordering. For example the odd/even interlacing embodiment where the vector length is 2K the first importance factors for any odd audio frame is the set I_{factor-odd}={2K, K, 2K−1, K−1, . . . , K+1, 1}—in other words the first vector selected is the first vector having an importance factor 2K, the third vector with an importance factor of 2K−1 is selected next, and so on. For any even audio frames the importance factors are the set I_{factor-even}={K, 2K, K−1, 2K−1, . . . , 1, K+1}. In the even audio frame the second vector having an importance factor 2K is selected first, the fourth vector with an importance factor of 2K−1 is selected next and so on.

Although the above example shows where the sub-vectors are re-ordered twice, embodiments of the invention may re-order the sub-vectors once, twice or more than twice.

Furthermore in the above example the spectral values are quantized into sub-vectors and then re-ordered, however it would be appreciated that in other embodiments of the invention these steps may be reversed so that the spectral values are first re-ordered and then the re-ordered spectral values may be quantized into sub-vectors.

Furthermore in some embodiments of the invention the spectral values can be divided into groups of spectral values, only some of the groups are interlaced/re-ordered and the remainder of the groups are unordered.

For example the encoded signal may comprise three groups, the first group may comprise the first part of the spectral values, the second group may comprise half of the later part of the spectral values and the third group may comprise the remainder of the later part of spectral values.

Transposing or re-ordering these spectral components therefore may comprise transposing the second group of spectral values so that when they are reordered they form the odd indexed spectral values of the later part of the re-ordered spectral values, and the third group are the re-ordered even indexed spectral values of the later part. Similarly the second group of spectral values may be reordered to become the even indexed spectral values of the re-ordered arrangement and the third group become the odd indexed spectral values.

This embodiment produces the advantages described below with respect to allowing a reduced set of spectral component to at least represent some of the higher frequency components by re-ordering high frequency spectral components within the mid frequency components, but with the additional advantage that the lower frequency components are protected by not being reordered.

In other embodiments of the present invention the index/interlace processor 1205 in the determination step 1306 may also determine a series of importance factors representing the importance of each quantised frequency coefficient value (sub-vector) with respect to all of the remaining frequency coefficients (sub-vectors), or may determine a series of importance factors representing the importance of each sub-band of frequency coefficient values (sub-vectors) with respect to each sub-band.

In these embodiments of the invention the index/interlace processor 1205 in the re-ordering step 1307, may re-order all of the coefficient values (sub-vectors) in dependence of their ‘global’ frequency coefficient value, or may re-order the coefficient values (sub-vectors) in dependence of their sub-band importance factor.

The above re-ordering and interlacing of the vectors in embodiments of the invention results in the improvement of the perceived signal received at the decoder described below. For example in discarding any specific layer in reducing the required bandwidth for the signal permits a full range of the perceived important frequency components to be transmitted.

To assist in the understanding of the above, and the advantages of such a system we will now describe a series of simplified examples to demonstrate various embodiments of the invention. These following examples feature a simplified system where there are 40 MDCT coefficients, which are used to form 10 4 dimensional (4D) sub-vectors. In this example the sub-bands of sub-vectors may be distributed in the following way:

Sub-band 1: 4 MDCT coefficients (1 sub-vector)
Sub-band 2: 8 MDCT coefficients (2 sub-vectors)
Sub-band 3: 12 MDCT coefficients (3 sub-vectors)
Sub-band 4: 16 MDCT coefficients (4 sub-vectors)

Furthermore the sub-vectors are encoded with the number of bits {7, 6, 6, 6, 4, 4, 4, 3, 3, 3} in increasing frequency order.

In an interlacing only example, the output of the concatenation (in other words the ordering of the sub-vectors) is:

frame 1 (odd)

S_{layer}={S_{odd};Sₑᵥₑₙ}, where
S_{odd} ={sub-band 1:[sv 1(7bits)]; sub-band 2:[sv 2(6bits)];
sub-band 3:[sv 2 (4bits)]; sub-band 4:[sv 1(4bits) sv 3(3bits)]}
and
Sₑᵥₑₙ = {sub-band 2:[sv 1 (6bits)]; sub-band 3:[sv 1(6bits)
sv 3(4bits)]; sub-band 4:[sv 2 (3bits) sv 4 (3 bits)]}

and thus
S_{layer}={ sub-band 1:[sv 1(7bits)]; sub-band 2:[sv 2(6bits)];
sub-band 3:[sv 2 (4bits)]; sub-band 4:[sv 1(4bits) sv 3(3bits)]
sub-band 2:[sv 1 (6bits)]; sub-band 3:[sv 1(6bits) sv 3(4bits)];
sub-band 4:[sv 2 (3bits) sv 4 (3 bits)]}
where sv is the sub-vector, and the layer is equivalent to the full
audio signal layer, in the exemplarily embodiment for this invention
this is termed the R5 layer.

Consider the situation where only 30 of the 46 bits per frame are received by the decoder—i.e. for instance a R4 layer rather than R5 layer is transmitted by a network. In such a situation a typical embedded scaleable or layered decoder not employing the scheme described by this invention would only receive complete information on the first and second sub-bands, partial information on the third sub-band and no information on the fourth sub-band.

However using embodiments of the present invention as shown above the decoder is able to receive partial information on all four sub-bands.

In a further example the combination of both re-ordering and interlacing is shown. In this second example it is determined that the importance factor of each sub-band is in decreasing order

{sub-band 1, sub-band 2, sub-band 4, sub-band 3}

Thus for frame 1 (odd)

S_{layer}={S_{odd};Sₑᵥₑₙ}, where
S_{odd} ={sub-band 1:[sv 1(7bits)]; sub-band 2:[sv 2(4bits)];
sub-band 4:[sv 1(4bits) sv 3(3bits)]; sub-band 3:[sv 2 (4bits)] }
and
Sₑᵥₑₙ = {sub-band 2:[sv 1 (6bits)]; sub-band 4:[sv 2 (3bits)
sv 4 (3 bits)]; sub-band 3:[sv 1(6bits) sv 3(4bits)] }

and thus
S_{layer}={ sub-band 1:[sv 1(7bits)]; sub-band 2:[sv 2(4bits)];
sub-band 4:[sv 1(4bits) sv 3(3bits)]; sub-band 3:[sv 2 (4bits)]
sub-band 2:[sv 1 (6bits)]; sub-band 4:[sv 2(3bits) sv 4 (3 bits)];
sub-band 3:[sv 1(6bits) sv 3(4bits)] }

As shown above, any reduction of the transmitted number of bits enables a more perceptually important distributed range of audio information to be received. For example a reduction of the number of bits to 30 would result in at least some information from all of the sub-bands being received. A reduction of the number of bits below 30 would reduce the number of sub-bands being received—however the perceived important sub-band 4 would be transmitted rather than the less important sub-band 3.

Listening tests conducted for speech signals show consistent improvements in layer R3 for codecs employing embodiments of the invention over codecs not employing embodiments of the invention.

For instance, comparisons in terms of the Perceptual Enhanced Speech Quality scores (PESQ an ITU-T standard P.862) for an embodiment of the invention only utilising the method of interlacing of the sub-vectors only is presented in Tables 3 and 4.

TABLE 3
PESQ score for speech and music samples without interlacing

| | (R4) 24 kbits/s |
|---|---|
| Music | 3.039 |
| Speech | 3.700 |
| Average | 3.370 |

TABLE 4
PESQ score for speech and music samples with interlacing

| | (R4) 24 kbits/s |
|---|---|
| Music | 3.250 |
| Speech | 3.731 |
| Average | 3.490 |

The multiplexer 215 outputs a multiplex signal which may then be transmitted or stored.

This multiplexing is shown in FIG. 3 by step 325.

The difference encoder controller 275 may be arranged to control the difference encoder 273 and the difference coder 213 in particular enabling the difference coder 213 to determine a series of scaling factors to be used on the MDCT coefficients of the difference signal and/or to be used to generate parameters used to determine the importance of sub-bands and/or sub-vectors of sub-bands.

Embodiments of the invention may thus use the correlation between the synthesized signal and the difference signal to enable the difference signal to be more optimally processed.

The synthesized signal is passed to a MDCT processor 251. In some embodiments of the invention the difference encoder controller MDCT processor 251 may be the same MDCT processor 211 used by the difference encoder 273.

The MDCT processing of the synthesized signal step is shown in FIG. 3 by step 313b.

The coefficients generated by the MDCT processor 251 are passed to a synthesized signal spectral processor 253. In some embodiments of the invention the operations of the synthesized signal spectral processor 253 may be performed by the difference coder 213.

The synthesized signal spectral processor 253 groups the coefficients into sub-bands in a manner previously described above with respect to the difference signal transformed coefficients. In a first embodiment of the invention the MDCT processor produces 280 synthesized signal coefficients and the same grouping as shown above in Table 1 may be applied to produce 22 sub-bands.

This grouping step is shown in FIG. 3 in step 315b.

The coefficients from each of the 22 sub-bands are then processed within the synthesized signal spectral processor 253 so that the root mean squared value for the MDCT synthesized signal coefficients per sub-band is calculated. This calculated root mean square value may be considered to indicate the energy value of the synthesised signal for each sub-band.

This root mean square calculation can be seen in FIG. 3 in step 317b.

This energy per sub-band may then be passed to the difference coder 213 in the difference encoder.

The difference coder then uses these energy values to calculate the scaling factors for each sub-band as described above and seen in FIG. 3 in step 317a and also may use these values to determine the sub-band importance and sub-vector importance values as described above.

In other embodiments of the present invention the synthesized signal spectral processor 253 may calculate the average magnitude of the coefficients lying within each sub-band, and may pass the resulting sub-band energy value of each coefficient to the difference coder 213 in order to generate the scaling/the sub-band importance (and sub-vector importance) values where each coefficient is scaled dependent on the value of the energy of the synthesised coefficient.

In further embodiments of the present invention the synthesised signal spectral processor 253 may locate a local maximum coefficient value within in sub-band, on a per sub-band basis.

In some embodiments of the present invention the synthesized signal spectral processor 253 calculates the root mean squared value and the average energy per coefficient per sub-band is calculated. The average energy per coefficient per sub-band is then passed to the difference coder 213 in order to generate a scaling factor/the sub-band importance (and sub-vector importance) values.

With respect to FIG. 4, an example of a decoder 400 for the codec is shown. The decoder 400 receives the encoded signal and outputs a reconstructed audio output signal.

The decoder comprises a demultiplexer 401, which receives the encoded signal and outputs a series of data streams. The demultiplexer 401 is connected to a core decoder 471 for passing the lower level bitstreams (R1 and/or R2). The demultiplexer 401 is also connected to a difference decoder 473 for outputting the higher level bitstreams (R3, R4, and/or R5). The core decoder is connected to a synthesized signal decoder 475 to pass a synthesized signal between the two. Furthermore the core decoder 471 is connected to a summing device 413 via a delay element 410 which also receives a synthesized signal. The synthesized signal decoder is connected to the difference decoder 473 for passing root mean square values for sub-band coefficients. The difference decoder 473 is also connected to the summing device 413 to pass a difference signal to the summing device. The summing device 413 has an output which is an approximation of the original signal.

With respect to the FIGS. 4 and 5 an example of the decoding of an encoded signal to produce an approximation of the original audio signal is shown.

The demultiplexer 401 receives the encoded signal, shown in FIG. 5 by step 501.

The demultiplexer 401 is further arranged to separate the lower level signals (R1 or/and R2) from the higher level signals (R3, R4, or/and R5). This step is shown in FIG. 5 in step 503.

The lower level signals are passed to the core decoder 471 and the higher level signals passed to the difference decoder 473.

The core decoder 471, using the core codec 403, receives the low level signal (the core codec encoded parameters) discussed above and performs a decoding of these parameters to produce an output the same as that produced by the synthesized signal output by the core codec 203 in the encoder 200. The synthesized signal is then up-sampled by the post processor 405 to produce a synthesized signal similar to the synthesized signal output by the core encoder 271 in the encoder 200. If however the core codec is operating at the same sampling rate as the eventual output signal, then this step is not required. The synthesized signal is passed to the synthesized signal decoder 475 and via the delay element 410 to the summing device 413.

The generation of the synthesized signal step is shown in FIG. 5 by step 505c.

The synthesized decoder 475 receives the synthesized signal. The synthesized signal is processed in order to generate a series of energy per sub-band values (or other correlation factor) using the same process described above. Thus the synthesized signal is passed to a MDCT processor 407. The MDCT step is shown in FIG. 5 in step 509. The MDCT coefficients of the synthesized signals are then grouped in the synthesized signal spectral processor 408 into sub-bands (using the predefined sub-band groupings—such as shown in Table 1). The grouping step is shown in FIG. 5 by step 513. The synthesized signal spectral processor 408 may calculate the root mean square value of the coefficients to produce an energy per sub-band value (in a manner shown above) which may be passed to the difference decoder 473. The calculation of the values is shown in FIG. 5 by step 515. As appreciated in embodiments where different values are generated within the encoder 200 synthesized signal spectral processor 253 the same process is used in the decoder 400 synthesized signal spectral processor 408 so that the outputs of the two devices are the same or close approximations to each other.

The difference decoder 472 passes the high level signals to the difference processor 409.

The difference processor 409 comprises an index/interlace processor 1401 which receives inputs from the demultiplexer 401 and outputs a processed signal to the scaling processor 1403. The index/interlace processor 1401 and the scaling processor 1403 may also receive further inputs, for example from the synthesized signal decoder 475 and/or a frame decision processor 1405 as will be described in further detail below.

The index/interlace processor 1401 demultiplexes from the high level signals the received scale factors and the quantized sub-vectors (scaled MDCT coefficients).

The difference processor then re-indexes the received scale factors and the quantized scaled MDCT coefficients. The re-indexing returns the scale factors and the quantized scaled MDCT coefficients into an order prior to the indexing carried out in the steps 323 and 325 with respect to the scale factors and coefficients.

An example of re-indexing with respect to the indexing process example described above is shown here. The decoding of the index I, consists of the decoding of Iₚₒₛ, and of I_{B}. To recover the position vector p from an index Iₚₒₛ, the following algorithm may be used:

1. i=0
2. while (M>0){
$find j such that {\sum }_{i = 1}^{j} ( \begin{matrix}n - i \\ M - 1\end{matrix} ) \leq {I}_{pos} < {\sum }_{i = 1}^{j + 1} ( \begin{matrix}n - i \\ M - 1\end{matrix} )$
pᵢ = j
${I}_{pos} = {I}_{pos} - {\sum }_{i = 1}^{j} ( \begin{matrix}n - i \\ M - 1\end{matrix} )$
n = n − j − 1
M = M − 1
i=i+1
}

The vector v may then be recovered by inserting the value 1 at the positions indicated in the vector p and the value 0 at all the other positions.

If the encoded signal was originally encoded with interlaced sub-vectors the index/interlace processor 1401 then de-interlaces the sub-vectors.

The de-interlacing process is shown with respect to steps 1501 to 1505 in FIG. 5b. The index/interlace processor 1401 first determines whether the current frame is an odd or even frame (shown in FIG. 5b as step 1501). This may be determined with the assistance of a frame decision processor 1405, which may keep a record of which frame is currently being processed, whether the frame is odd or even, and whether any special reordering needs to be carried out with respect to the current frame number and provide this information to the index/interlace processor 1401 and/or the scaling processor 1403. The operation of the frame decision processor 1405 may be incorporated in some embodiments of the invention into the index/interlace processor 1401 and/or the scaling processor 1403.

If the frame is odd then the index/interlace processor 1401 separates the received signal into S_{odd} and Sₑᵥₑₙ groups of sub vectors (shown in FIG. 5b in step 1503a), the index/interlace processor 1401 then rewrites the original S vector by alternately adding a sub-vector from each of the odd and even vector groups starting from the odd group (as shown in FIG. 5b as step 1505a). If the frame is even then the index/interlace processor 1401 separates the received signal into S_{odd} and Sₑᵥₑₙ groups of sub vectors (shown in FIG. 5b in step 1503b), the index/interlace processor 1401 then rewrites the original S vector by alternately adding a sub-vector from each of the odd and even vector groups starting from the even group (as shown in FIG. 5b in step 1505b).

The index/interlace processor 1401 may also perform a de-ordering of the sub-vectors where embodiments of the invention have carried out a reordering of the sub-vector in the encoder.

The index/interlace processor 1401 may first determine the original re-ordering of the sub-vectors. In embodiments where the original re-ordering is pre-defined (such as the interlacing example above) the de-ordering importance factors process can be known in advance. In some embodiments of the invention the de-ordering factors defining the process of selection may be transmitted to the decoder 400 in a separate channel. In further embodiments of the invention the decoder may use information from other layers to determine the de-order values.

The determination of the de-order values is shown in FIG. 5b in step 1505.

For example in embodiments where the re-ordering factors were generated dependent on parameters from the synthesized signal processor the same factors may be generated from the synthesised signal decoder 475 by carrying out the same steps.

The index/interlace processor 1401 may, once the de-ordering factors are determined use the received sub-vectors and the factors to perform a de-ordering of the sub-vectors to arrive at an approximation of the original vector.

Once the original re-ordering factors are generated it is within the ability of the skilled person to regenerate at least part of the original sub-vector arrangement with the received sub-vectors and the known original re-ordering factors. For example in the encoding example provided above where the third and fourth subgroups are swapped the sub-vectors of the received third and fourth groups may be swapped back.

The de-ordering of the sub-vectors is shown in FIG. 5b in step 1507.

A similar process may be carried out on any received sub-vectors.

The re-indexing/de-lacing/de-ordering of the coefficient values is shown in FIG. 5 as step 505a, and the re-indexing/de-lacing/de-ordering of the scaling factors as step 505b.

The difference decoder 472 furthermore re-scales the coefficient values.

Thus using the re-indexed scaled values determined in step 505b, the inverse to the third scaling process (step 321) is performed.

This sub-band factor re-scaling is shown in FIG. 5 as step 507.

The difference decoder 472 rescales the coefficients using the predetermined factor—in other words performing the inverse to the second scaling process (step 319).

This pre-determined factor re-scaling is shown in FIG. 5 as step 511.

The difference decoder 472, having received the energy based values of the sub-bands of the synthesized signal from the synthesized processor 475 uses these values in a manner similar to that described above to generate a series of re-scaling factors to perform the inverse to the first scaling process (step 317a).

This synthesized signal factor re-scaling operation is shown in FIG. 5 as step 517.

According to the embodiment of the present invention only the required re-scaling operations may be required on the coefficients. Thus where only the first scaling operation is carried out on the coefficients only step 517 from steps 507, 511 and 517 are performed. Similarly steps 507 or 511 may be not performed if one or other of the optional second or third scaling operations is not performed in the coding of the signal.

The difference decoder 473 re-index and re-scale processor outputs the re-scaled and re-indexed MDCT coefficients representing the difference signal. This is then passed to an inverse MDCT processor 411 which outputs a time domain sampled version of the difference signal.

This inverse MDCT process is shown in FIG. 5 as step 519.

The time domain sampled version of the difference signal is then passed from the difference decoder 473 to the summing device 413 which in combination with the delayed synthesized signal from the coder decoder 471 via the digital delay 410 produces a copy of the original digitally sampled audio signal.

This combination is shown in FIG. 5 by the step 521.

The above described a procedure using the example of a VMR audio codec. However, similar principles can be applied to any other speech or audio codec.

In the example provided above of the present invention the MDCT (and IMDCT) is used to convert the signal from the time to frequency domain (and vice versa). As would be appreciated any other appropriate time to frequency domain transform with an appropriate inverse transform may be implemented instead. Non limiting examples of other transforms comprise: a discrete Fourier transform (DFT), a fast Fourier transform (FFT), a discrete cosine transform (DCT-I, DCT-II, DCT-III, DCT-IV etc), and a discrete sine transform (DST).

The embodiments of the invention described above describe the codec 10 in terms of separate encoders 200 and decoders 400 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

For example the core codec 403 and post processor 405 of the decoder may be implemented by using the core coder 203 and post processor 205. The synthesized signal decoder 475 similarly may be implemented by using the synthesized signal encoder 275 of the encoder. Thus circuitry and/or programming objects or code may be reused when ever the same process is operated.

The embodiment shown above provides a more accurate result due to the correlation between the difference and the synthesized signals enabling the scaling factors dependent on the synthesized signals when used to scale the difference signal MDCT coefficients produces a better quantized result.

The combination of the correlation scaling, the predetermined scaling and the sub-band factor scaling may produce a more accurate result than the prior art scaling processes at no additional signalling cost.

Furthermore as the synthesized signals are recreated from the low level signals the scaling factors are always part of the transmitted encoded signal even if some of the high level signals are not transmitted due to bandwidth capacity constraints. In other words by using the inherent information in the correlation between the synthesized signal generated from the core codec and the original difference signal the additional scaling factors featured in embodiments described in the invention are not sent separately (like the factors sent in some embodiments of the invention). Therefore embodiments of the invention may show a higher coding efficiency when compared with systems where multiple sets of scaling factors are transmitted separately as a higher percentage of the transmitted signal is signal information (either core codec or encoded difference signal) rather than scaling information.

Although the above examples describe embodiments of the invention operating within a codec within an electronic device 610, it would be appreciated that the invention as described below may be implemented as part of any variable rate/adaptive rate audio (or speech) codec where the difference signal (between a synthesized and real audio signal) may be quantized. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus, comprising:
an encoder configured to:
generate for a first time period of the audio signal a first encoded signal comprising a plurality of spectral values;
determine at least one factor value, each factor value being mapped to at least one of the plurality of spectral values, and
transpose the at least one of the plurality of spectral values dependent on the factor value.

2. (canceled)

3. An encoder as claimed in claim 1, wherein the encoder is configured to determine the at least one factor value dependent on at least one of:
a predetermined value;
a parameter dependent on the mapped at least one spectral value;
a parameter dependent on the mapped at least one spectral value and at least one further spectral value.

4. An encoder as claimed in claim 1, wherein the first encoded signal comprises at least two groups, each group comprising a plurality of spectral values, and wherein each factor having a mapping to each group, and
wherein the encoder is configured to transpose at least one of the spectral values of at least one group of the spectral values dependent on the factor value.

5. An encoder as claimed in claim 1, wherein the first encoded signal comprises two groups, the first group comprising odd indexed spectral values and the second group comprising even indexed spectral values.

6. An encoder as claimed in claim 5, wherein the encoder is configured to transpose the first group of spectral values so that all of the first group spectral values precede the second group spectral values.

7. An encoder as claimed in claim 6, wherein the encoder is further configured to transpose the first group of spectral values so that all of the second group spectral values precede the first group spectral values.

8. An encoder as claimed in claim 7, wherein the encoder is configured to generate for a second time period of the audio signal a second encoded signal comprising a second plurality of spectral values,
wherein the second encoded signal comprises two further groups, the first further group comprising odd indexed spectral values of the second encoded signal and the second further group comprising even indexed spectral values of the second encoded signal,
wherein the encoder is configured to transpose the first further group of spectral values so that a transposed second encoded signal comprises all of the first further group spectral values preceding the second further group spectral values when the first time period transposed signal comprises all of the second group spectral values preceding the first group spectral values, and
the encoder is configured to transpose the first further group of spectral values so that a transposed second encoded signal comprises all of the second further group spectral values preceding the first further group spectral values when the first time period transposed signal comprises all of the first group spectral values preceding the second group spectral values.

9. (canceled)

10. A method comprising:
generating for a first time period of the audio signal a first encoded signal comprising a plurality of spectral values;
determining at least one factor value, each factor value being mapped to at least one of the plurality of spectral values; and
transposing the at least one of the plurality of spectral values dependent at least in part on the factor value.

11. (canceled)

12. A method for encoding as claimed in claim 10, wherein determining comprises determining the at least one factor value dependent on at least one of:
a predetermined value;
a parameter dependent on the mapped at least one spectral value;
a parameter dependent on the mapped at least one spectral value and at least one further spectral value.

13. A method for encoding as claimed in claim 12, wherein the first encoded signal comprises at least two groups, each group comprising a plurality of spectral values, and wherein each factor being mapped to each group, and wherein transposing comprises transposing at least one of the spectral values of at least one group of the spectral values dependent on the factor value.

14. A method for encoding as claimed in claim 10, wherein the first encoded signal comprises two groups, the first group comprising odd indexed spectral values and the second group comprising even indexed spectral values.

15. A method for encoding as claimed in claim 14, wherein transposing comprises transposing the first group of spectral values so that all of the first group spectral values precede the second group spectral values.

16. A method for encoding as claimed in claim 15, wherein transposing comprises transposing the first group of spectral values so that all of the second group spectral values precede the first group spectral values.

17. A method for encoding as claimed in claim 16, further comprising:
generating for a second time period of the audio signal a second encoded signal comprising a second plurality of spectral values, wherein the second encoded signal comprises two further groups, the first further group comprising odd indexed spectral values of the second encoded signal and the second further group comprising even indexed spectral values of the second encoded signal,
transposing the first further group of spectral values such that a transposed second encoded signal comprises all of the first further group spectral values preceding the second further group spectral values when all of the second group spectral values precede the first group spectral values, and
transposing the first further group of spectral values such that a transposed second encoded signal comprises all of the second further group spectral values preceding the first further group spectral values when the all of the first group spectral values precede the second group spectral values.

18. (canceled)

19. An apparatus, comprising:
a decoder configured to:
receive for a first time period of an audio signal a first encoded signal comprising a plurality of spectral values;
determine at least one factor value, each factor value being mapped to at least one of the plurality of spectral values, and
transpose the at least one of the plurality of spectral values dependent on the factor value.

20. (canceled)

21. A decoder as claimed in claim 19, wherein the decoder is configured to determine the at least one factor value dependent on at least one of:
a predetermined value;
a parameter dependent on the mapped at least one spectral value;
a parameter dependent on the mapped at least one spectral value and at least one further spectral value.

22. A decoder as claimed in claim 21, wherein the first encoded signal comprises at least two groups, each group comprising a plurality of spectral values, and wherein each factor having a mapping to each group,
wherein the decoder is configured to transpose at least one of the spectral values of at least one group of the spectral values dependent on the factor value.

23. A decoder as claimed in claim 19, wherein the first encoded signal comprises two groups, the first group comprising a preceding half of the spectral values and the second group comprising the remainder spectral values.

24. A decoder as claimed in claim 23, wherein the decoder is configured to transpose the first group of spectral values such that the first group are transposed as the odd indexed spectral values, and the second group are the even indexed spectral values.

25. A decoder as claimed in claim 24, wherein the decoder is configured to transpose the first group of spectral values such that the first group are transposed as the even indexed spectral values, and the second group are the odd indexed spectral values.

26. A decoder as claimed in claim 25, wherein the decoder is configured to receive for a second time period of the audio signal a second encoded signal comprising a second plurality of spectral values, wherein the second encoded signal comprises two further groups, the first further group comprising a preceding half of the spectral values and the second further group comprising the remainder spectral values,
wherein the decoder is configured to transpose the first further group of spectral values such that the first further group are transposed as the odd indexed spectral values, and the second further group are the even indexed spectral values when the first time period transposed signal comprises the first group as the even indexed spectral values, and the second group are the odd indexed spectral values, and
the decoder is configured to transpose the first further group of spectral values such that the first further group are transposed as the even indexed spectral values, and the second further group are the odd indexed spectral values when the first time period transposed signal comprises the first group as the even indexed spectral values, and the second group are the odd indexed spectral values.

27. (canceled)

28. A method comprising:
receiving for a first time period of an audio signal a first encoded signal comprising a plurality of spectral values;
determining at least one factor value, each factor value being mapped to at least one of the plurality of spectral values; and
transposing the at least one of the plurality of spectral values dependent at least in part on the factor value.

29. (canceled)

30. A method as claimed in claim 27, wherein determining comprises determining the at least one factor value dependent on at least one of:
a predetermined value;
a parameter dependent on the mapped at least one spectral value;
a parameter dependent on the mapped at least one spectral value and at least one further spectral value.

31. A method as claimed in claim 30, wherein the first encoded signal comprises at least two groups, each group comprising a plurality of spectral values, and wherein each factor having a mapping to each group, transposing comprising transposing at least one of the spectral values of at least one group of the spectral values dependent on the factor value.

32. A method as claimed in claim 27, wherein the first encoded signal comprises two groups, the first group comprising a preceding half of the spectral values and the second group comprising the remainder spectral values.

33. A method as claimed in claim 32, transposing comprising transposing the first group of spectral values such that the first group are transposed as the odd indexed spectral values, and the second group are the even indexed spectral values.

34. A method as claimed in claim 33, transposing comprising transposing the first group of spectral values such that the first group are transposed as the even indexed spectral values, and the second group are the odd indexed spectral values.

35. A method as claimed in claim 34, comprising receiving for a second time period of the audio signal a second encoded signal comprising a second plurality of spectral values, wherein the second encoded signal comprises two further groups, the first further group comprising a preceding half of the spectral values and the second group comprising the remainder spectral values,
further transposing the first further group of spectral values such that the first further group are transposed as the odd indexed spectral values, and the second further group are the even indexed spectral values when the first time period transposed signal comprises the first group as the even indexed spectral values, and the second group are the odd indexed spectral values, and
further transposing the first further group of spectral values such that the first further group are transposed as the even indexed spectral values, and the second further group are the odd indexed spectral values when the first time period transposed signal comprises the first group as the even indexed spectral values, and the second group are the odd indexed spectral values.

36-38. (canceled)

39. A computer program product in which a software code is stored in computer readable medium, wherein said code realizes the following when being executed by a processor:
generating for a first time period of the audio signal a first encoded signal comprising a plurality of spectral values;
transposing at least one of the plurality of spectral values; and
determining at least one factor value, each factor value being mapped to at least one of the plurality of spectral values, wherein transposing comprises transposing the at least one of the plurality of spectral values dependent on the factor value.

40. A computer program product in which a software code is stored in a computer readable medium, wherein said code realizes the following when being executed by a processor:
receiving for a first time period of an audio signal a first encoded signal comprising a plurality of spectral values;
transposing at least one of the plurality of spectral values; and
determining at least one factor value, each factor value being mapped to at least one of the plurality of spectral values, wherein transposing comprises transposing the at least one of the plurality of spectral values dependent on the factor value.

41-44. (canceled)
